(19) United States
(12) Patent Application Publication
(10) Pub. No.: US 2025/0023511 A1
(43) Pub. Date: Jan. 16, 2025

(54) PHOTOVOLTAIC POWER GENERATION DEVICE WITH CLEANING FUNCTION

(71) Applicant: Hebei Qinhuai Data Co., Limited., Zhangjiakou City (CN)

(72) Inventor: Binghua ZHANG, Zhangjiakou City (CN)

(21) Appl. No.: 18/764,309

(22) Filed: Jul. 4, 2024

(30) Foreign Application Priority Data
Jul. 13, 2023 (CN) 202310861377.5

(51) Int. Cl. H02S 40/10; A46B 13/02; B08B 1/12; B08B 1/32

(52) U.S. Cl. CPC H02S 40/10; A46B 13/02; B08B 1/12; B08B 1/32; A46B 2200/3073

(57) ABSTRACT

The present disclosure discloses a photovoltaic power generation device with cleaning function, specifically relates to the field of photovoltaic power generation technology, and includes a support seat. A moving mechanism is arranged on the support seat, a first support plate is fixedly connected to the support seat, a fixed cylinder is fixedly connected to the first support plate, interior of the fixed cylinder is connected to a rotating block through a bearing, and the rotating block is fixedly connected to a second support plate.

### CROSS REFERENCE TO RELATED APPLICATION

This application claims priority to Chinese Patent Application No. 202310861377.5, titled “PHOTOVOLTAIC POWER GENERATION DEVICE WITH CLEANING FUNCTION” and filed to the China National Intellectual Property Administration on Jul. 13, 2023, the entire contents of which are incorporated herein by reference.

### TECHNICAL FIELD

The present disclosure relates to the field of photovoltaic power generation technology, and more particularly, to a photovoltaic power generation device with cleaning function.

### BACKGROUND

With continuous development of social economy and continuous progress of human civilization, Human demands for energy are constantly increasing, and energy problems have become global problems. Chemical energy source currently used by humans is not a clean energy source, and the existing exploitable energy sources can no longer sustain sustainable human development. Thus, fully utilizing solar energy has become an inevitable trend. The solar energy is clean, environmentally-friendly and inexhaustible, and does not cause any environmental pollution. The solar energy is the most abundant renewable energy source available to humans. According to an invention patent with patent authorization announcement number CN209517011U, a photovoltaic power generation device and a photovoltaic power generation bracket thereof are disclosed, including a bottom plate. A side wall on the bottom plate is connected to a rotating plate through a rotating mechanism, and a side wall on the rotating plate is fixedly connected to a fixed block, which is fixedly connected to a connecting rod, where other end of the connecting rod is fixedly connected to a mounting plate. In the present disclosure, there are provided a holding rod, a threaded rod, a first bevel gear, a second bevel gear, a rotating rod, a rotary table, a fixed seat, a moving column, a fixed rod, and a slide block. By rotating the holding rod, the holding rod drives the rotary table to rotate, the rotary table drives the rotating rod to rotate, the rotating rod drives the second bevel gear to rotate, the second bevel gear drives the first bevel gear to rotate, the first bevel gear drives the threaded rod to rotate, and the threaded rod drives the moving column to move. As a result, the moving column drives the slide block to move, such that the slide block slides on the fixed rod, and an angle of the mounting plate is adjusted. In this way, an angle of a photovoltaic panel is adjusted, such that the photovoltaic panel can fully receive sunlight. However, in existing technologies, the photovoltaic panels may be covered by dust in the air during use, which has a negative effect on daylighting effects of the panels. Furthermore, the photovoltaic power generation devices are inconvenient to transport or move when required.

### SUMMARY

The present disclosure provides a photovoltaic power generation device with cleaning function, aiming to solve a problem that daylighting effects may be adversely affected because a photovoltaic panel is likely covered by dust, to solve a problem of inconvenient transportation or movement of the photovoltaic power generation device.

According to embodiments of the present disclosure, there is provided a photovoltaic power generation device with cleaning function, which includes a support seat. A moving mechanism is arranged on the support seat, and a first support plate is fixedly connected to the support seat. A fixed cylinder is fixedly connected to the first support plate, where interior of the fixed cylinder is connected to a rotating block through a bearing. The rotating block is fixedly connected to a second support plate, and a regulating device is fixedly connected to the second support plate. The regulating device is fixedly connected to a fixed plate, and the fixed plate is provided with a photovoltaic panel and a cleaning mechanism.

In the photovoltaic power generation device with cleaning function of the present disclosure, the cleaning mechanism includes a baffle plate, a first motor, a moving rod, a first threaded rod, a second motor, a rotating rod, a brush, and a connecting block. The fixing plate is fixedly connected to the baffle plate, and the baffle plate is fixedly connected to the first motor, where an output terminal of the first motor is fixedly connected to the first threaded rod. The first threaded rod is connected to the baffle plate through a bearing, an outer side of the first threaded rod is connected to the moving rod through a screw thread, and the moving rod is slidably connected to the baffle plate. By starting the first motor, the moving rod can be driven to move on the threaded rod.

In the photovoltaic power generation device with cleaning function of the present disclosure, a second motor is fixedly connected to the moving rod, and a rotating rod is fixedly connected to an output terminal of the second motor. A brush is fixedly connected to the rotating rod, and the brush is slidably connected to the fixing plate. By starting the second motor, the brush can be driven to clean the photovoltaic panel.

In the photovoltaic power generation device with cleaning function of the present disclosure, an outer side of the rotating rod is connected to a connecting block through a bearing, and the connecting block is slidably connected to the baffle plate. By arranging the connecting block, stability of the rotating rod during movement can be increased.

In the photovoltaic power generation device with cleaning function of the present disclosure, the moving mechanism includes a T-shaped rotating rod, a first bevel gear, a second bevel gear, a second threaded rod, a moving frame, a universal wheel, and a guide groove. The interior of the fixed cylinder is connected to the T-shaped rotating rod through a bearing, and the first bevel gear is fixedly connected to the T-shaped rotating rod. The first bevel gear is meshed with the second bevel gear, and interior of the second bevel gear is fixedly sleeved with the second threaded rod. The second threaded rod is connected to the fixed cylinder through a bearing, and the second threaded rod is connected to the first support plate through a bearing, where an outer side of the second threaded rod is connected to the moving frame through a screw thread. By rotating the T-shaped rotating rod, the moving frame can be driven to move vertically.

In the photovoltaic power generation device with cleaning function of the present disclosure, the moving frame comes into contact with the first support plate, and four symmetrically distributed universal wheels are fixedly connected to the moving frame. By arranging the universal wheels, convenience of the photovoltaic power generation device during movement can be increased.

In the photovoltaic power generation device with cleaning function of the present disclosure, four symmetrically distributed guide grooves are provided inside the support seat, and the moving frame is slidably connected to interior of each of the four guide grooves. Stability of the moving frame during movement can be increased by arranging the guide grooves.

The technical solutions provided by the embodiments of the present disclosure may include following beneficial effects.

There are provided structures such as the first motor, the moving rod, the first threaded rod, the second motor, and the brush. By starting the first motor, the moving rod and the second motor can be driven to move along a direction of the first threaded rod. By starting the second motor, the brush can be driven to rotate and clean the fixed plate and the photovoltaic panel. By starting the first motor and the second motor simultaneously, the photovoltaic panel can be cleaned, making the photovoltaic panel more stable during daylighting, which improves stability of the photovoltaic power generation device during use.

2. There are provided structures such as the T-shaped rotating rod, the second threaded rod, the moving frame, and the universal wheel. By rotating the T-shaped rotating rod, the second threaded rod can be driven to rotate. Rotation of the second threaded rod can drive the moving frame and the universal wheel to move along a direction of the guide groove. When the universal wheel moves to contact with ground, the photovoltaic power generation device can be transferred and moved through the universal wheel. When the universal wheel is moved to no longer come into contact with the ground and the support seat comes into contact with the ground, the photovoltaic power generation device can be placed. By arranging the moving mechanism, convenience of using the photovoltaic power generation device is increased.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a three-dimensional view of an overall structure according to the present disclosure;

FIG. 2 is an elevation cross-sectional view of FIG. 1 according to the present disclosure; and

FIG. 3 is a downward-looking cross-sectional view of FIG. 2 according to the present disclosure.

Reference numerals in the accompanying drawings:

support seat 1; first support plate 2; fixed cylinder 3; rotating block 4; second support plate 5; regulating device 6; fixed plate 7; cleaning mechanisms 8; baffle plate 81; first motor 82; moving rod 83; first threaded rod 84; second motor 85; rotating rod 86; brush 87; connecting block 88; moving mechanism 9; T-shaped rotating rod 91; first bevel gear 92; second bevel gear 93; second threaded rod 94; moving frame 95; universal wheel 96; guide groove 97; and photovoltaic panel 10.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

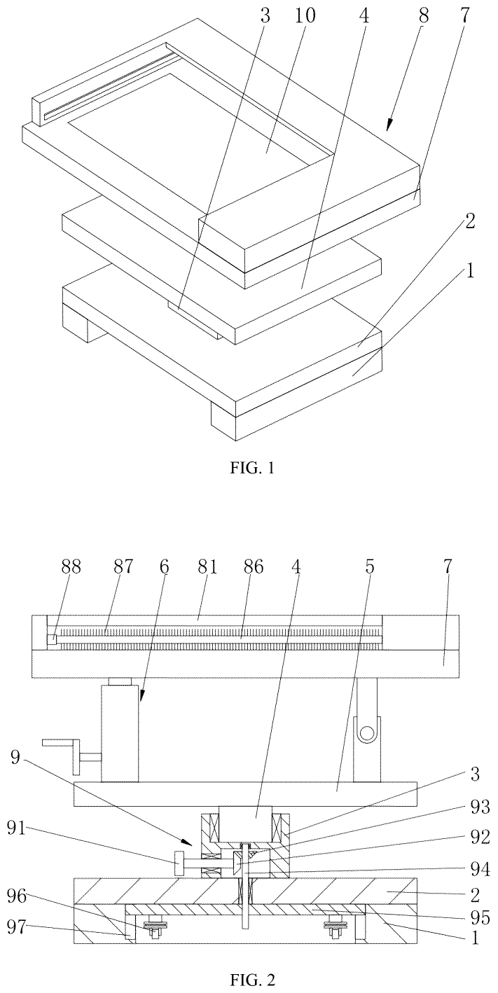

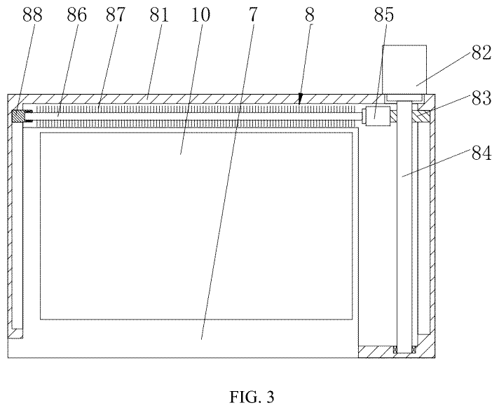

Referring to FIG. 1, FIG. 2, and FIG. 3, a photovoltaic power generation device with cleaning function includes a support seat 1. A moving mechanism 9 is arranged on the support seat 1, and a first support plate 2 is fixedly connected to the support seat 1. A fixed cylinder 3 is fixedly connected to the first support plate 2, where interior of the fixed cylinder 3 is connected to a rotating block 4 through a bearing. The rotating block 4 is fixedly connected to a second support plate 5, and a regulating device 6 is fixedly connected to the second support plate 5. The regulating device 6 is fixedly connected to a fixed plate 7, and the fixed plate 7 is provided with a photovoltaic panel 10 and a cleaning mechanism 8.

Referring to FIG. 2 and FIG. 3, the cleaning mechanism 8 includes a baffle plate 81, a first motor 82, a moving rod 83, a first threaded rod 84, a second motor 85, a rotating rod 86, a brush 87, and a connecting block 88. The fixing plate 7 is fixedly connected to the baffle plate 81, and the baffle plate 81 is fixedly connected to the first motor 82, where an output terminal of the first motor 82 is fixedly connected to the first threaded rod 84. The first threaded rod 84 is connected to the baffle plate 81 through a bearing, an outer side of the first threaded rod 84 is connected to the moving rod 83 through a screw thread, and the moving rod 83 is slidably connected to the baffle plate 81. By starting the first motor 82, the moving rod 83 can be driven to move on the threaded rod. The second motor 85 is fixedly connected to the moving rod 83, and the rotating rod 86 is fixedly connected to an output terminal of the second motor 85. The brush 87 is fixedly connected to the rotating rod 86, and the brush 87 is slidably connected to the fixing plate 7. By starting the second motor 85, the brush 87 can be driven to clean the photovoltaic panel 10. An outer side of the rotating rod 86 is connected to the connecting block 88 through a bearing, and the connecting block 88 is slidably connected to the baffle plate 81. By arranging the connecting block 88, stability of the rotating rod 86 during movement can be increased.

Referring to FIG. 2, the moving mechanism 9 includes a T-shaped rotating rod 91, a first bevel gear 92, a second bevel gear 93, a second threaded rod 94, a moving frame 95, a universal wheel 96, and a guide groove 97. The interior of the fixed cylinder 3 is connected to the T-shaped rotating rod 91 through a bearing, and the first bevel gear 92 is fixedly connected to the T-shaped rotating rod 91. The first bevel gear 92 is meshed with the second bevel gear 93, and interior of the second bevel gear 93 is fixedly sleeved with the second threaded rod 94. The second threaded rod 94 is connected to the fixed cylinder 3 through a bearing, and the second threaded rod 94 is connected to the first support plate 2 through a bearing, where an outer side of the second threaded rod 94 is connected to the moving frame 95 through a screw thread. By rotating the T-shaped rotating rod 91, the moving frame 95 can be driven to move vertically, such that the moving frame 95 comes into contact with the first support plate 2. Four symmetrically distributed universal wheels 96 are fixedly connected to the moving frame 95. By arranging the universal wheels 96, convenience of the photovoltaic power generation device during movement can be increased. Four symmetrically distributed guide grooves 97 are provided inside the support seat 1, and the moving frame 95 is slidably connected to interior of each of the four guide grooves 97. Stability of the moving frame 95 during movement can be increased by arranging the guide grooves 97.

Specific implementation processes of the present disclosure are as follows. by arranging the regulating device 6, an angle of the photovoltaic panel 10 can be adjusted to improve daylighting effects of the photovoltaic panel 10. When it is needed to clean the photovoltaic panel 10, the first motor 82 is started, such that the output terminal of the first motor 82 drives the first threaded rod 84 to rotate. Because the first threaded rod 84 is connected to the moving rod 83 through a screw thread, the rotation of the first threaded rod 84 can drive the moving rod 83 to perform threaded motion, such that the moving rod 83 can move along the direction of the first threaded rod 84. Simultaneously, the second motor 85 is started, such that the output terminal of the second motor 85 drives the rotating rod 86 to rotate. The rotation of the rotating rod 86 can drive the brush 87 to rotate, and the rotation of the brush 87 can clean the photovoltaic panel 10 through the brush 87. The photovoltaic panel 10 is more stable during daylighting, thereby increasing the stability of the photovoltaic power generation device during use. The T-shaped rotating rod 91 is manually rotated to drive the first bevel gear 92 to rotate. The rotation of the first bevel gear 92 can drive the second bevel gear 93 to rotate, and the rotation of the second bevel gear 93 can drive the second threaded rod 94 to rotate. Because the second threaded rod 94 is connected to the moving frame 95 through a screw thread, the rotation of the second threaded rod 94 can drive the moving frame 95 to perform threaded motion, thereby driving the moving frame 95 to move vertically along the direction of the guide groove 97. The movement of the moving frame 95 can drive the universal wheel 96 to move. When the universal wheel 96 moves to contact with ground, the photovoltaic power generation device can be transferred and moved through the universal wheel 96. When the universal wheel 96 is moved to no longer come into contact with the ground and the support seat 1 comes into contact with the ground, the photovoltaic power generation device can be placed. By arranging the moving mechanism 9, convenience of using the photovoltaic power generation device is increased.

The preceding descriptions are merely specific embodiments of the present disclosure, but the protection scope of the present disclosure is not limited thereto. Any equivalent modifications or replacements easily conceivable to a person of skilled in the art within the technical scope disclosed in the present disclosure shall fall within the protection scope of the present disclosure. Therefore, the protection scope of the present disclosure shall be subject to that of the claims.

What is claimed is:

1. A photovoltaic power generation device with cleaning function, comprising a support seat, wherein a moving mechanism is arranged on the support seat, a first support plate is fixedly connected to the support seat, a fixed cylinder is fixedly connected to the first support plate, interior of the fixed cylinder is connected to a rotating block through a bearing, the rotating block is fixedly connected to a second support plate, a regulating device is fixedly connected to the second support plate, the regulating device is fixedly connected to a fixed plate, the fixed plate is provided with a photovoltaic panel and a cleaning mechanism.

2. The photovoltaic power generation device with cleaning function according to claim 1, wherein the cleaning mechanism comprises a baffle plate, a first motor, a moving rod, a first threaded rod, a second motor, a rotating rod, a brush, and a connecting block; the fixing plate is fixedly connected to the baffle plate, the baffle plate is fixedly connected to the first motor, an output terminal of the first motor is fixedly connected to the first threaded rod, the first threaded rod is connected to the baffle plate through a bearing, an outer side of the first threaded rod is connected to the moving rod through a screw thread, and the moving rod is slidably connected to the baffle plate.

3. The photovoltaic power generation device with cleaning function according to claim 2, wherein a second motor is fixedly connected to the moving rod, and a rotating rod is fixedly connected to an output terminal of the second motor, a brush is fixedly connected to the rotating rod, and the brush is slidably connected to the fixing plate.

4. The photovoltaic power generation device with cleaning function according to claim 2, wherein an outer side of the rotating rod is connected to a connecting block through a bearing, and the connecting block is slidably connected to the baffle plate.

5. The photovoltaic power generation device with cleaning function according to claim 1, wherein the moving mechanism comprises a T-shaped rotating rod, a first bevel gear, a second bevel gear, a second threaded rod, a moving frame, a universal wheel, and a guide groove; the interior of the fixed cylinder is connected to the T-shaped rotating rod through a bearing, the first bevel gear is fixedly connected to the T-shaped rotating rod, the first bevel gear is meshed with the second bevel gear, interior of the second bevel gear is fixedly sleeved with the second threaded rod, the second threaded rod is connected to the fixed cylinder through a bearing, the second threaded rod is connected to the first support plate through a bearing, and an outer side of the second threaded rod is connected to the moving frame through a screw thread.

6. The photovoltaic power generation device with cleaning function according to claim 5, wherein the moving frame comes into contact with the first support plate, and four symmetrically distributed universal wheels are fixedly connected to the moving frame.

7. The photovoltaic power generation device with cleaning function according to claim 1, wherein four symmetrically distributed guide grooves are provided inside the support seat, and a moving frame is slidably connected to interior of each of the four guide grooves.
